(19) United States
(12) Patent Application Publication
(10) Pub. No.: US 2013/0025561 A1
(43) Pub. Date: Jan. 31, 2013

(54) BOWL RIM AND ROOT PROTECTION FOR ALUMINUM PISTONS

(71) Applicants: Dieter Gabriel, Highland, MI (US); Wolfgang Rein, Milford, MI (US); Thomas Stong, Kent City, MI (US); David Domanchuk, Grand Haven, MI (US); Thomas J. Smith, Muskegon, MI (US)

(72) Inventors: Dieter Gabriel, Highland, MI (US); Wolfgang Rein, Milford, MI (US); Thomas Stong, Kent City, MI (US); David Domanchuk, Grand Haven, MI (US); Thomas J. Smith, Muskegon, MI (US)

(21) Appl. No.: 13/192,774

(22) Filed: Jul. 28, 2011

(51) Int. Cl. F02F 3/12; B05D 1/02; B05D 7/14

(52) U.S. Cl. 123/193.6; 427/236; 427/422

(57) ABSTRACT

A piston including a piston crown, the piston crown having a combustion surface that further defines a combustion bowl rim area and a bowl root area. A thermal spray coating is applied to the bowl rim and/or the bowl root area of the piston to increase the resistance of the piston to thermal mechanical fatigue. The thermal spray coating may be metal or alloy based and may be applied using any suitable process.

### FIELD

The present disclosure is related to a thermal spray coating for a piston for use in high temperature and/or high pressure environments such as that of an internal combustion engine. In particular, the present disclosure is related to a thermal spray coating that may be applied to the bowl rim and/or the root area of a piston to improve its thermal mechanical fatigue resistance.

### BACKGROUND

An internal combustion engine generally comprises a reciprocating piston disposed within a cylindrical cavity of an engine block. One end of the cylindrical cavity may be closed while another end of the cylindrical cavity may be open. The closed end of the cylindrical cavity and an upper portion or crown of the piston defines a combustion chamber where fuel is burned. The expansion of the gases produced during combustion applies direct force to the piston. Thus the open end of the cylindrical cavity permits reciprocating movement of the piston within the cylindrical cavity. A crank shaft connected to the piston converts the linear motion of the piston (resulting from the combustion of fuel in the combustion chamber) into rotational motion throughout the engine cycle.

During the engine cycle, whether it is a two-stroke engine, a four-stroke engine, etc., the piston and other engine components are subjected to high pressure and high thermal loads. These stresses can cause thermal cracking on the piston head, cracking at the combustion bowl edge, higher wear in the ring groove, and other stresses that may result in material fatigue and/or component failure. Thus, durability and thermal mechanical fatigue are limiting factors in piston applications.

Ceramic barrier coatings have been applied to engine components operating at high pressures and elevated temperatures. These coatings serve to insulate metallic components from high thermal loads that may be prolonged or reoccurring. They also permit higher operating temperatures while limiting thermal exposure of the components. However, ceramic barrier coatings have not proven durable.

Accordingly, there is a need for a thermal spray coating for an aluminum piston that increases the resistance of a piston to thermal mechanical fatigue, permitting higher engine temperatures and extending the life of the piston.

### BRIEF DESCRIPTION OF THE DRAWINGS

FIG. 1A illustrates a partial cutaway view of an exemplary piston.

FIG. 1B illustrates a perspective view of the exemplary piston shown in FIG. 1.

FIG. 2 is a flow diagram of an exemplary method of making the piston shown in FIG. 1.

### DETAILED DESCRIPTION

Referring now to the discussion that follows and also to the drawings, illustrative approaches are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

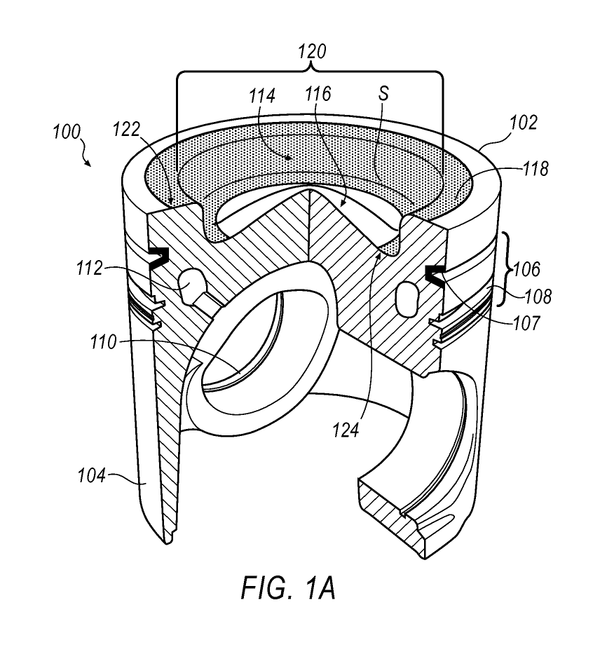

FIGS. 1A and 1B illustrate an exemplary piston having a thermal spray coating applied to the bowl rim area and the root area of a piston for use in high temperature and/or high pressure environments such as that of an internal combustion engine. In the illustrated approach an aluminum piston is utilized. While an exemplary piston is shown in FIGS. 1A and 1B, the exemplary components illustrated in the figures are not intended to be limiting. Indeed, additional or alternative components and/or implementations may be used.

More specifically, an exemplary piston 100 is illustrated in FIGS. 1A and 1B. Piston 100 may be formed using any suitable process including, but not limited to, casting, forging, or assembling the piston from individual components. The piston 100 may include a piston crown 102 and a piston skirt 104. The piston crown 102 and the piston skirt 104 may be constructed from any suitable material or combination of suitable materials, including aluminum. Aluminum pistons are commonly used because they are light weight, durable, and because they are generally less expensive to manufacture than other piston types, such as steel pistons.

As discussed above, the crown 102 and the skirt 104 may be formed using different processes. For example, the crown 102 and the skirt 104 may be formed as one piece by casting or forging. The crown 102 may also be a single cast piece, while the skirt 104 may be forged. In another exemplary approach, the piston crown 102 and the piston 104 may be formed separately such that the piston crown 102 and the piston skirt 104 may be assembled and fixedly secured to one another in any suitable manner including, but not limited to, welding methodologies.

The piston crown 102 may include a combustion bowl 120 and a ring belt portion 106 configured to seal against an engine bore (not shown) receiving the piston 100. For example, the ring belt portion 106 may define one or more circumferential grooves 108 that receive piston rings (not shown), which in turn seal against engine bore surfaces during reciprocal motion of the piston 100 within the engine bore. In one exemplary approach, the circumferential grooves 108 may include a ring groove insert 107. Such inserts are commonly used in cast pistons for the top and/or second piston ring grooves. The insert 107 may be a NiResist insert or any other suitable insert.

The ring belt portion 106 of the crown 102 may define, at least in part, a cooling gallery 112. The cooling gallery 112 generally extends about a perimeter of the piston crown 102, and may be cooled by oil during operation, thereby reducing an operating temperature of the piston. Additionally, the oil may facilitate and help maintain a more stable or uniform temperature about the piston 100, especially in the upper portion of the piston 100.

The piston skirt 104 generally supports the crown 102 during engine operation by interfacing with surfaces of an engine bore (not shown) to stabilize the piston 100 during reciprocal motion within the bore. The skirt 104 may also define piston pin bosses 110. The piston pin bosses 110 may generally be formed with apertures configured to receive a piston pin (not shown). For example, a piston pin may be inserted through the apertures in the piston pin bosses 110, thereby generally securing the skirt 104 to a connecting rod (not shown).

In one exemplary approach, the crown 102 and the skirt 104 may form a continuous combustion bowl surface S in the combustion bowl area 120 of the piston 100. The combustion bowl surface S may be a substantially smooth to reduce disruptions and/or discontinuities in the surface S. The crown 102 may define a radially outer portion 114 of the combustion bowl surface S, while the skirt 104 may define a radially inner portion 116 of the combustion bowl surface S. However, the combustion bowl surface S may also take on other suitable configurations. For example, in another exemplary approach, the crown 102 may define the combustion bowl surface S in its entirety. That is, forming of the piston crown 102 may involve forging, casting and/or machining several different features of the piston crown 102, such as, the combustion bowl 120. Therefore, in some piston assemblies, the crown 102 may define the first radially outer portion 114 of the combustion bowl surface S and the radially inner portion 116 of the combustion bowl surface S

A protective thermal coating may be applied to the non-wall engaging surfaces of the piston 100, including but not limited to, the bowl rim area 122 and the bowl root area 124 of the combustion bowl surface S. Unlike the piston skirt 104 and the ring belt portion 106, for example, the non-wall engaging surfaces do not frictionally engage an engine bore. Nonetheless, the piston and more specifically the crown 102, may be subjected to high pressure and high thermal loads. Stresses of this nature may cause undesirable thermal cracking in various regions of the piston 100 including cracking along the rim of the combustion bowl 120, discussed in more detail below. Such cracking may lead to material fatigue and ultimately to component failure. However, a thermal spray coating applied only to the non-wall engaging areas of the piston may increase the resistance of the piston to thermal mechanical fatigue in these areas. Resistance to such fatigue may permit higher engine temperatures and extend the life of the piston.

Moreover, application of the thermal coating to only those areas most susceptible to material fatigue provides both economic and time saving advantages during manufacturing. For example, application of the thermal coating only where necessary, such as to the bowl rim area 122 and the bowl root area 124 of the combustion bowl surface S, reduces the amount of thermal coating material needed. That is, the thermal coating is applied only to those areas that need the most protection, as opposed to the entire piston, thus reducing the cost of manufacture.

Reducing the application of the thermal coating only to those areas most susceptible to material fatigue also decreases the manufacturing time of the pistons. In addition, application of the thermal coating only to the non-wall engaging surfaces eliminates manufacturing complexities that may arise when a coating is applied to an entire piston, including the piston skirt. That is, application of the thermal coating to only the non-wall engaging surfaces does not affect the seal formed between the piston and the engine bore surfaces during reciprocal motion of the piston.

In the exemplary piston illustrated in FIGS. 1A and 1B, a thermal spray coating 118 has been applied to the area of the combustion surface S defining the bowl rim 122. The coating may be used in an as-sprayed state or may be machined after application. The thermal spray coating 118 may be metallic or alloy based and comprised of an iron based material, a nickel based material, a copper based material, an aluminum based material, a cobalt based material, a molybdenum based material, or any other suitable material or combination thereof. The thermal spray coating 118 may be applied to the bowl rim area 122 of the aluminum piston using any suitable process including, but not limited to, plasma, HVOF, wire flame spray, powder flame spray, and wire arc spray. In another exemplary approach, a spray and fuse type thermal spray coating may be applied. The thermal spray coating may be applied to the piston and a secondary method of heat, such as a laser, torch, electron beam, etc., may be used to fuse the thermal spray. The thermal spray may also be applied as a multi-layer coating, which may include layers of different composition, or as a gradient coating, which may include a gradient blend of materials.

As illustrated, the thermal spray 118 extends partially along an upper surface of the bowl rim 122. The thermal spray 118 may also be applied such that the thermal coat extends downwardly from the bowl rim area 122 to cover the radially outer portion 114 of the combustion bowl surface S. However, the application of the thermal spray 118 to the bowl rim area 122 may vary based on the design of piston, the intended application of the piston, and other factors. For example, in another exemplary approach, the thermal spray 118 may extend across the entire upper surface of the bowl rim 122.

The thermal spray coating 118 may be applied along a portion of the bowl rim area 122. The thermal spray coating 118 may be applied evenly up to approximately 10 mm or in a range of thicknesses up to approximately 10 mm. This improves the thermal mechanical fatigue resistance of the base material. Moreover, the addition of the thermal spray 118 to the bowl rim area 122 allows an aluminum piston, in particular, to run at temperatures and/or pressures above that of a typical non-coated aluminum piston. Thus, lower cost aluminum pistons may be used in higher temperature and/or pressure applications as opposed to implementation of higher cost steel pistons.

The thermal spray coating 118 may also be applied to the bowl root area 124 of the piston 100. As illustrated, the thermal spray 118 extends partially along the radially inner portion 116 of the combustion bowl surface S. However, again, the application of the thermal spray 118 to the root area 124 may vary based on the design of the piston, the intended application of the piston, and other factors. For example, in another exemplary approach, the thermal spray 118 may be applied to the entire radially inner portion 116. Moreover, like the bowl rim area 122, the thermal spray coating 118 may be applied to the bowl root area 124 evenly up to approximately 10 mm or in a range of thicknesses up to approximately 10 mm.

Although one exemplary approach is illustrated in FIGS. 1A and 1B, the thermal spray coating 118 may be applied to any type of piston, including but not limited to, pistons of varying size, and pistons having different combustion bowl geometries. Also, as discussed above, the thermal spray coating 118 may be applied to areas of the combustion surface S or to the entire piston. The thermal spray coating 118 may be applied evenly to the areas identified above, or in some exemplary approaches, the thermal spray coating 118 may be applied with varying thicknesses. Regardless, proper application of the thermal spray coating 118 is paramount to the success of the thermal spray coating.

As discussed above, application of the thermal spray coating 118 to the bowl rim area 122 and/or bowl root area 124 of the piston 100 increases the resistance of the piston to thermal mechanical fatigue. The thermal spray coating 118 may also protect the base material of the piston. Indeed, as discussed above, the base material of the piston 100 may be comprised of various types of materials. In some exemplary approaches, the thermal spray coating 118 may also be comprised of the same material as the base material of the piston such that the piston 100 and the thermal spray coating 118 have a similar expansion rate. The similar expansion rate protects the base material from crack initiation, which may occur as a result of dissimilar expansion rates. In another exemplary approach, the thermal spray coating 118 may be comprised of a more ductile material than the base material of the piston 100 preventing cracks from forming as a result of thermal mechanical stress.

Accordingly, the thermal spray coating 118 allows the piston to operate at higher temperatures and/or pressures than an uncoated piston of the same base material. Thus, in some circumstances an uncoated piston used in an original engine may be coated with the thermal spray coating 118 and utilized in a modified engine. This may be advantageous in applications where, for example, modification of engine calibration is done to improve fuel economy. Such modifications typically result in higher temperatures and/or pressures at the combustion bowl. Thus, the application of a thermal spray coating 118 to the rim area 122 and/or the bowl root area 124 of the piston 100 allows the piston to withstand higher temperatures and/or pressures. Moreover, application of the thermal spray coating 118 to an aluminum piston allows aluminum pistons to be used in higher temperature and/or pressures applications as opposed to implementations of higher cost steel pistons.

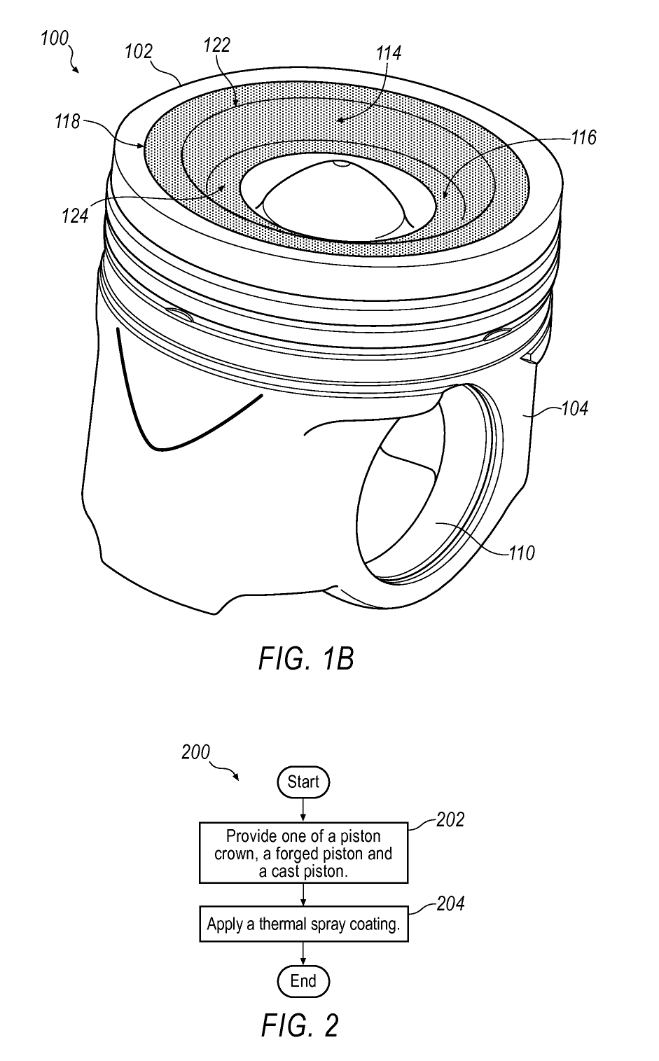

Turning now to FIG. 2, a process flow diagram for an exemplary method 200 of forming a piston having a thermal spray coating is illustrated. Process 200 may generally begin at block 202, where the crown of a partial piston, or a cast or forged piston is provided. Pre-machining of the piston may be performed using any known and suitable machining techniques.

Proceeding to block 204, a thermal spray coating 118 may be applied to areas of the combustion surface S defining the bowl rim area 122 and/or the bowl root area 124 of the combustion bowl 120. The thermal spray coating 118 may be metal or alloy based and may be applied using any suitable process. Such processes may include, but are not limited to, plasma, HVOF, wire flame spray, powder flame spray, and wire arc spray. As discussed above, the thermal spray coating 118 may be applied along a portion of the bowl rim area 122 evenly up to approximately 10 mm or in a range of thicknesses up to approximately 10 mm. Similarly, the thermal spray coating 118 may be applied along a portion of the bowl root area 124 evenly up to approximately 10 mm or in a range of thickness of up to approximately 10 mm. After application of the thermal spray, machining of the piston may be performed using any known and suitable machining techniques.

The exemplary piston 100 illustrated herein generally may allow for increased resistance to thermal mechanical fatigue. Further, the piston 100 may also offer aluminum pistons capable of operating at higher engine temperatures and/or pressures and for prolonged periods of time. Thus, the piston 100 having a thermal spray coating 118 offers reduced manufacturing costs as a result of the manufacturing flexibilities offered by aluminum pistons as opposed to more expensive steel pistons. Although the thermal coating is described as being applied only to those areas most susceptible to thermal fatigue, i.e. to the bowl rim area 122 and the bowl root area 124 of the combustion bowl surface S, in some exemplary assemblies, the thermal coating may be applied to the entire piston.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

What is claimed is:

1. A piston comprising:
a piston crown defining at least a portion of a combustion bowl, wherein the combustion bowl has a combustion bowl surface; and
a thermal spray coating applied to a non-wall engaging surface, such as a portion of the combustion bowl surface, wherein the thermal spray is configured to increase the resistance of the piston to thermal mechanical fatigue.

2. The piston of claim 1, wherein the piston crown defines a bowl rim area and a first portion of the combustion bowl surface, the first portion being a radially outer portion.

3. The piston of claim 2, wherein the thermal spray is applied only to a portion of the bowl rim area and the radially outer portion.

4. The piston of claim 2, wherein the thermal spray extends between at least a portion of the bowl rim area and the first radially outer portion.

5. The piston of claim 1, wherein the piston crown further defines a second portion of the combustion bowl surface, the second portion being a radially inner portion.

6. The piston of claim 5, wherein at least a portion of the radially inner portion defines a bowl root area.

7. The piston of claim 6, wherein the thermal spray is applied only to a portion of the bowl root area.

8. The piston of claim 1, wherein the thermal spray is one of an iron based material, a nickel based material, a copper based material, an aluminum based material, a cobalt based material, and a molybdenum based material.

9. The piston of claim 1, wherein the thermal spray is applied to the combustion bowl surface at a thickness of up to 10 mm.

10. The piston of claim 1, wherein the thermal spray is fused after applied to the non-wall engaging surface

11. The piston of claim 1, wherein the thermal spray has an expansion rate substantially similar to the expansion rate of at least one of the piston crown and the piston skirt.

12. The piston of claim 1, wherein the thermal spray is one of a multi-layer coating or a gradient coating.

13. A piston comprising:
an aluminum piston crown defining at least a portion of a combustion bowl, wherein the combustion bowl includes a bowl rim area and a bowl root area; and
a thermal spray coating applied only to a non-wall engaging surface, such as one of the bowl rim area and the bowl root area.

14. The piston of claim 13, wherein the thermal spray is one of an iron based material, a nickel based material, a copper based material, an aluminum based material, a cobalt based material, and a molybdenum based material.

15. The piston area of claim 13, wherein the thermal spray extends between at least a potion of the bowl rim area and the bowl root area.

16. The piston of claim 13, wherein the thermal spray is applied evenly to the bowl rim area and the bowl root area.

17. The piston of claim 13, wherein the thermal spray has an expansion rate substantially similar to the expansion rate of at least one of the piston crown and the piston skirt.

18. A method of forming a piston comprising:
providing an aluminum piston crown, the piston crown defining at least a portion of a combustion bowl, wherein the combustion bowl includes a bowl rim area and a bowl root area; and
applying a thermal spray coating to a non-wall engaging surface, such as one of the bowl rim area and the bowl root area to increase the resistance of the piston to thermal mechanical fatigue.

19. The method of claim 18, wherein the thermal spray coating is one of iron based material, a nickel based material, a copper based material, an aluminum based material, a cobalt based material, and a molybdenum based material.

20. The method of claim 18, wherein, the thermal spray coating is applied only to at least one of the bowl rim area and the bowl root area
